(19) United States
(12) Patent Application Publication
(10) Pub. No.: US 2003/0080133 A1
(43) Pub. Date: May 1, 2003

(54) Rapid reach system

(76) Inventor: Herbert Butler, New York, NY (US)

Correspondence Address: COOK, ALEX, MCFARRON, MANZO, CUMMINGS & MEHLER LTD, SUITE 2850, 200 WEST ADAMS STREET, CHICAGO, IL, 60606, US

(21) Appl. No.: 10/091,777

(22) Filed: Mar. 5, 2002

Related U.S. Application Data
(60) Provisional application No. 60/336,029, filed on Oct. 31, 2001.

(51) Int. Cl. A47J 39/00; A47J 41/00; B65D 81/38; B65D 83/72

(52) U.S. Cl. 220/592.2

(57) ABSTRACT

A cooler with a flap in the lid of the cooler to provide easy access to the contents of the cooler without having to lift the lid open.

### BACKGROUND OF THE INVENTION

The present invention relates generally to portable refrigeration receptacles and soft sided coolers, and more particularly to a system for providing quick and easy access to the contents within the receptacle or cooler.

Numerous coolers are known in the art. Previously, coolers came in two types, the styrofoam cooler or the hard plastic cooler. The styrofoam cooler was liked by consumers because it was relatively inexpensive to buy and could be discarded after use. This type of cooler, however, had a number of drawbacks such as, for example, it easily broke, was not recyclable when discarded, often had to be replaced and was bulky to store and pack. The hard plastic cooler was liked by consumers because it was sturdy, would not break and did not continually have to be replaced. This type of cooler was also bulky to store and pack and could be fairly expensive. Further, both of these types of coolers were difficult to carry.

As a result, soft-sided coolers were developed. These coolers were advantageous because they could be compacted and folded when not in use, did not require a lot of storage space and could be more easily fit into spaces when packing. Such coolers are also advantageous in that a strap could be placed on the cooler, and the cooler could be easily carried. These coolers typically are of the lunch box or picnic type or larger.

All of these coolers, however, required that the entire lid be opened in order to get at items inside the cooler. In soft-sided coolers, opening the lid required either unzipping the entire lid or ripping open the velcro located all around the lid. Either way, the entire lid had to be opened to reach the items inside and then the lid had to be completely closed to keep the items inside cold.

One object of the present invention is directed to a cooler and system which overcomes the disadvantages of these prior devices and provides for quick access to the items in the cooler.

### SUMMARY OF THE PRESENT INVENTION

The present invention is directed to a cooler and system for providing quick and easy access to items within a cooler.

In one embodiment, the present invention is directed to a cooler having a flap within the top lid of the cooler. The flap is advantageous for providing access to the cooler without having to open and close the lid of the cooler.

In a further embodiment, the cooler is a soft-sided cooler.

In a further embodiment, a portion of the flap is coupled to the lid by a fastening apparatus, such as for example, velcro.

In a further embodiment, the flap has a strap for ease in opening the cooler.

### BRIEF DESCRIPTION OF THE DRAWINGS

FIG. 1 is a front perspective view of a soft-sided cooler in accordance with an embodiment of the present invention.

FIG. 2 is a top perspective view of the cooler of FIG. 1, with the flap down.

FIG. 3 is a front perspective view of the cooler of FIG. 1, with the flap open.

### DESCRIPTION OF THE PREFERRED EMBODIMENTS

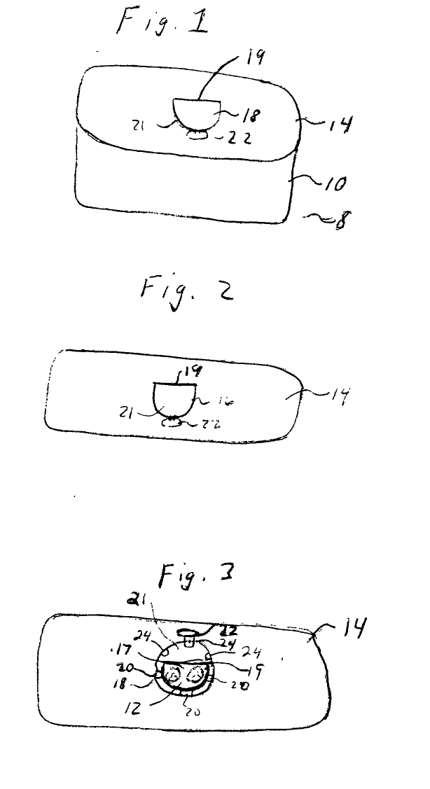

FIGS. 1-3 show an embodiment of a cooler in accordance with the present invention. The figures are merely intended to illustrate but not limit the present invention.

In this embodiment, the cooler 8 is a soft-sided cooler. The cooler 8 has a soft thermally insulated body 10 with a cavity 12 therein which defines an open ended storage region. The storage region holds food and/or beverages to be transported. While the present invention is not limited as to the size of the body or cavity, in a preferred embodiment, the cooler would be able to hold twenty-four 12 oz. beverage cans and ice. Alternately, the cooler could be smaller, such as a snack or lunch cooler, or larger. As is well known in the art, the cooler body will include a thermally insulated foam or other type of insulated material sandwiched between external layers of polyethylene, nylon or other suitable material. While the cooler is shown to have a rectangular shape, other shapes such as for example round or square are also contemplated as being within the present invention. In addition, a shoulder strap (not shown) can also be added to the cooler. Other means for carrying the cooler such as handles (not shown) are also contemplated. A plastic inset (not shown) can also be placed inside cavity 12. The cooler could also have pockets (not shown) located on the sides of the cooler.

A lid 14 is connected to the body 10 of the cooler 8. Preferably, a part of lid 14 is permanently connected to body 10 while another part is connected to body 10 using a zipper, velcro or other fastening type apparatus (not shown). Preferably, lid 14 is also made of a nylon or polyethylene type material and has insulation therein. Lid 14 opens to provide complete access to cavity 12 for loading and unloading the cooler.

Sometimes, however, a user of the cooler does not want to completely unzip and open the lid to get one item out of the cooler, such as for example a beverage can. Accordingly, the present invention is directed to a system for being able to rapidly reach items within the cooler.

In the embodiment shown in the figures, the system includes a flap in the lid. Flap 16 is an example of such a flap and is within lid 14, as shown in FIGS. 1-3. FIG. 2 is a top view of lid 14 showing flap 16 in the closed position. FIG. 3 is a top view of lid 14 showing flap 16 in the open position.

As shown in FIG. 3, lid 14 includes an opening 17 therein with a rim 18 around said opening. The present invention is not limited to the size and shape of the opening. This rim 18 preferably has fastening apparatus such as velcro pieces 20 on said rim. Within lid 14 is flap 16. Preferably, one portion 19 of flap 16 is permanently and pivotably connected to lid 14, by for example stitching or glue or similar means, at one part of opening 17. Another portion 21 of flap 16 covers the remaining part of opening 17. Flap 16 preferably has connecting fastening apparatus such as velcro pieces 24 to removably couple portion 21 of flap 16 to lid 14, and particularly to rim 18. In particular, portion 21 is designed to open and provide easy access to cavity 12 and the contents therein. The velcro pieces 24 on flap 16 are meant to couple to the velcro pieces 20 on rim 18 of lid 14. Preferably, flap 16 also has a pull strap or tab 22.

The lid and flap apparatus of this embodiment of the present invention is highly advantageous by allowing one to remove a beverage or other item from the cooler by merely opening flap 16, instead of opening up the entire lid. In a further embodiment, one merely has to grab pull tab 22 and pull it up to open flap 16, which allows easy access, through opening 17, to quickly grab an item from within the cooler and then pull tab 22 down to close flap 16 and quickly close the opening to the cooler.

It will be understood that the embodiments of the present invention which have been described are illustrative of some of the applications of the principles of the present invention. Numerous modifications may be made by those skilled in the art without departing from the true spirit and scope of the invention.

I claim:

1. A soft-sided cooler comprising:
a thermally insulated body having a cavity defining an open-ended storage region;
a lid connected to said body to close the open end of said cavity; and
a flap covering an opening within said lid,
wherein at least a portion of said flap is removably coupled to said lid to provide access to said cavity and said storage region through said opening.

2. The cooler of claim 1 wherein said flap provides access to said cavity and said storage region without opening said lid.

3. The cooler of claim 1 wherein one portion of said flap is permanently attached to said lid and forms a pivot point on said lid and another portion of said flap is removably coupled to said lid via a fastening apparatus to close said flap and to open said flap to provide access to said opening in said lid and to said cavity and storage region of said cooler.

4. The cooler of claim 3 wherein said fastening apparatus is velcro.

5. The cooler of claim 4 wherein said flap and said lid have opposing pieces of velcro thereon which couple to each other to keep said flap closed.

6. The cooler of claim 1 further comprising a pull tab on said flap for ease in opening said flap.

7. The cooler of claim 1 further comprising a carrying strap.

8. An insulated container comprising:
a thermally insulated body having a cavity defining an op en-ended storage region;
a lid connected to said body to close the open end of said cavity; and
a flap within said lid and covering an opening in said lid,
wherein said flap is pivotably coupled to said lid to provide access to said cavity and said storage region through said opening.

9. A soft-sided cooler comprising:
a thermally insulated body having a cavity defining an open-ended storage region;
a lid connected to said body to close the open end of said cavity; and
a flap covering an opening within said lid,
wherein one portion of said flap is permanently attached to said lid and forms a pivot point on said lid and another portion of said flap is removably coupled to said lid via a fastening apparatus to close said flap and to open said flap to provide access to said opening in said lid and to said cavity and storage region of said cooler; and
wherein said flap provides access to said cavity and said storage region without opening said lid.

10. The cooler of claim 3 wherein said fastening apparatus is velcro.

11. The cooler of claim 4 wherein said flap and said lid have opposing pieces of velcro thereon which couple to each other to keep said flap closed.

12. The cooler of claim 1 further comprising a pull tab on said flap for ease in opening said flap.

13. The cooler of claim 1 further comprising a carrying strap.
